(19) United States
(12) Patent Application Publication
(10) Pub. No.: US 2004/0261595 A1
(43) Pub. Date: Dec. 30, 2004

(54) Punch with a head having two compact layers that differ in hardness and coefficient of expansion

(75) Inventor: Ching-Kwang Lee, Pingtung City (TW)

Correspondence Address: Paul D. Greeley, Esq., Ohlandt, Greeley, Ruggiero & Perle, L.L.P., 10th Floor, One Landmark Square, Stamford, CT, 06901-2682, US

(73) Assignee: MAJOR INDUSTRIES LTD.

(21) Appl. No.: 10/790,308

(22) Filed: Mar. 1, 2004

Related U.S. Application Data
(63) Continuation-in-part of application No. 10/607,174, filed on Jun. 26, 2003.

(51) Int. Cl. B26D 1/00; C11D 17/00

(52) U.S. Cl. 83/651; 83/697

(57) ABSTRACT

A punch includes a punch body and a punch head. The punch head includes a first compact layer of cobalt-containing tungsten carbide welded to the punch body, and a second compact layer of cobalt-containing tungsten carbide welded to the first compact layer opposite to the punch body. The first compact layer has a hardness lower than that of the second compact layer, and has a coefficient of expansion greater than that of the second compact layer and smaller than that of the punch body.

### BACKGROUND OF THE INVENTION

1. Field of the Invention

The invention relates to a punch, more particularly to a punch which includes a punch head having two compact layers that differ in hardness and coefficient of expansion.

2. Description of the Related Art

Punches and dies are generally made from cobalt-containing tungsten carbide, which possesses excellent hardness and wear resistance. However, such hardness has an adverse effect on the punches in that the greater the hardness, the more brittle will be the punches. As such, the aforementioned punches tend to break after a period of use.

Referring to FIG. 1, another type of punch 1 has been proposed to overcome the aforesaid drawback. The punch 1 includes a metal rod portion 12 and a cobalt-containing tungsten carbide portion 11 welded onto the metal rod portion 12. However, the punch 1 also tends to break at the interface between the metal rod portion 12 and the cobalt-containing tungsten carbide 11 during a punching operation due to welding stress in the aforesaid interface and due to a relatively great difference between the coefficients of expansion of the metal rod portion 12 and the cobalt-containing tungsten carbide 11 at high temperatures, which are usually present during the punching operation.

A sandwich-type punch has been proposed to overcome this drawback. The sandwich-type punch is modified from the previous punch 1 by including a relatively soft metal portion sandwiched between and welded to the metal rod portion and the cobalt-containing tungsten carbide portion. However, the soft metal portion of the punch tends to deform after a period of use.

Referring to FIG. 2, U.S. Pat. No. 2,888,247 disclosed a rock drill cutting insert 2, which is built up of two or more layers of different wear resistance and toughness. The rock drill cutting insert 2 is usually fastened onto a support member 21. The influence of the difference between the coefficients of expansion of the rock drill cutting insert 2 and the support member 21 on the breakage at the interface therebetween is not suggested in the prior art.

### SUMMARY OF THE INVENTION

The object of the present invention is to provide a punch which includes a punch head having excellent hardness while maintaining relatively high toughness. A punch according to this invention includes a punch body and a punch head. The punch head includes a first compact layer of cobalt-containing tungsten carbide welded to the punch body, and a second compact layer of cobalt-containing tungsten carbide welded to the first compact layer opposite to the punch body. The first compact layer has a hardness lower than that of the second compact layer, and has a coefficient of expansion greater than that of the second compact layer and smaller than that of the punch body.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a conventional punch;

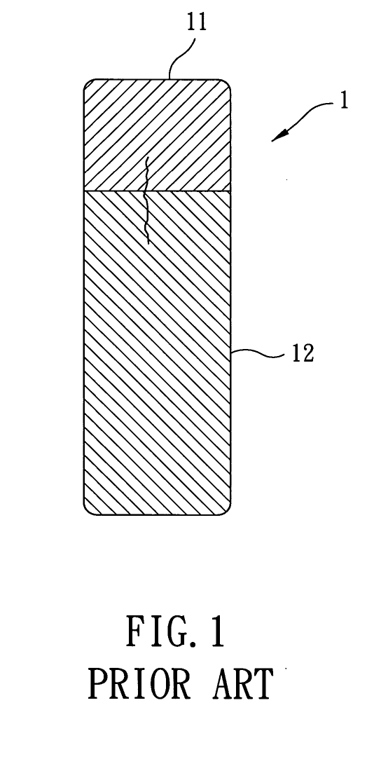

FIG. 2 is a schematic view of a rock drill cutting insert according to U.S. Pat. No. 2,888,247; and

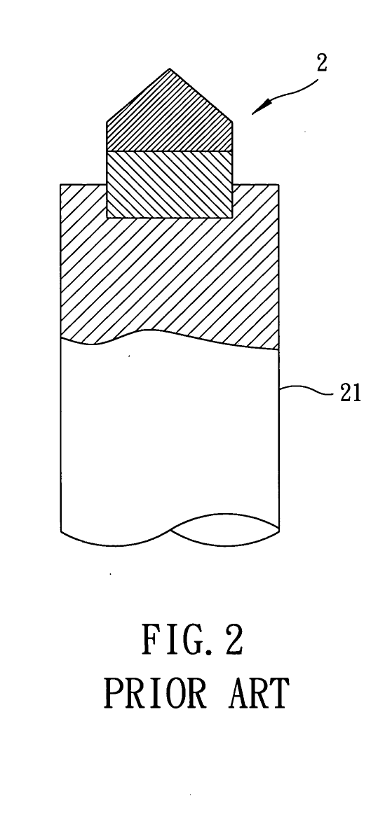

FIG. 3 is a schematic view of the preferred embodiment of the punch according to this invention.

### DETAILED DESCRIPTION OF THE PREFERRED EMBODIMENT

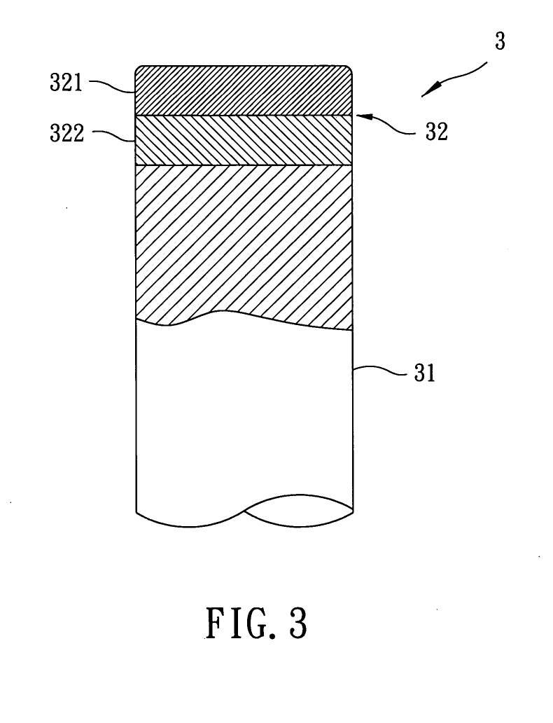

Referring to FIG. 3, the preferred embodiment of the punch 3 according to this invention is shown to include a punch body 31 and a punch head 32. The punch head 32 includes a first compact layer 322 of cobalt-containing tungsten carbide welded to the punch body 31, and a second compact layer 321 of cobalt-containing tungsten carbide welded to the first compact layer 322 opposite to the punch body 31. The first compact layer 322 has a hardness lower than that of the second compact layer 321, and has a coefficient of expansion greater than that of the second compact layer 321 and smaller than that of the punch body 31. The difference in hardness for the first and second compact layers 322, 321 can be accomplished by providing different amounts of cobalt in the first and second compact layer 322, 321, or by providing different particle sizes of tungsten carbide contained in the first and second compact layers 322, 321.

As described above, the first compact layer 322 has a coefficient of expansion greater than that of the second compact layer 321 and smaller than that of the punch body 31. In other words, the difference between the coefficient of expansion of the first compact layer 322 and that of the punch body 31 is smaller than the difference between the coefficient of expansion of the second compact layer 321 and that of the punch body 31. Furthermore, the second compact layer 321 has a hardness greater than that of the first compact layer 322. The thus formed punch 3 not only possesses a high degree of hardness, but also has enhanced toughness as compared to that of the prior art. As a consequence, the wear resistance of the punch head 32 of the punch 3 is relatively enhanced, and the breakage and deformation problems as encountered in the prior art can also be avoided.

The following Examples 1 to 4 illustrate variations in hardness with changes in weight percentage of cobalt. The results are listed in Table 1. As shown in Table 1, the greater the amount of cobalt contained in the compact layer, the lower will be the hardness of the compact layer of the punch head 32.

TABLE 1

| | Cobalt wt % | Tungsten wt % | Hardness, HAR |
|---|---|---|---|
| Example 1 | 5 | 95 | 90 |
| Example 2 | 10 | 90 | 89 |
| Example 3 | 15 | 85 | 85 |
| Example 4 | 20 | 80 | 84 |

The following Examples 5 to 8 illustrate variations in hardness with changes in particle size of tungsten carbide. The results are listed in Table 2. As shown in Table 2, the smaller the particle size of tungsten carbide contained in the compact layer, the greater will be the hardness of the compact layer of the punch head 32.

TABLE 2

| | | Particle size of | |
|---|---|---|---|
| | | tungsten carbide, | Hardness, |
| | Cobalt wt % | μm | HAR |
| Example 5 | 10 | 0.6 | 89 |
| Example 6 | 10 | 2.0 | 86 |
| Example 7 | 5 | 0.8 | 90 |
| Example 8 | 5 | 10 | 89 |

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A punch comprising:
a punch body; and
a punch head including a first compact layer of cobalt-containing tungsten carbide welded to said punch body, and a second compact layer of cobalt-containing tungsten carbide welded to said first compact layer opposite to said punch body,
wherein said first compact layer has a hardness lower than that of said second compact layer, and has a coefficient of expansion greater than that of said second compact layer and smaller than that of said punch body.

2. The punch as claimed in claim 1, wherein said first compact layer contains an amount of tungsten carbide that is less than that of said second compact layer.

3. The punch as claimed in claim 1, wherein the tungsten carbide contained in said first compact layer has a particle size greater than that of the tungsten carbide contained in said second compact layer.
